(19) United States
(12) Patent Application Publication
(10) Pub. No.: US 2015/0371456 A1
(43) Pub. Date: Dec. 24, 2015

(54) System and Method for Detecting and Remotely Assessing Vehicle Incidents and Dispatching Assistance

(71) Applicant: Hertz System, Inc., Park Ridge, NJ (US)

(72) Inventors: Robert D. Moore, JR., Oklahoma City, OK (US); Michael McDowell, Westwood, NJ (US)

(73) Assignee: Hertz System, Inc., Park Ridge, NJ (US)

(21) Appl. No.: 14/313,642

(22) Filed: Jun. 24, 2014

(51) Int. Cl. G07C 5/00; G06K 9/00; G01S 19/13

(52) U.S. Cl. CPC G07C 5/008; G01S 19/13; G06K 9/00838; G06K 9/00791

(57) ABSTRACT

A system and method for detecting and remotely assessing a vehicle incident and dispatching assistance to a motorist. The system includes an in-car device for detecting vehicular incidents such as mechanical failures and collisions. The system transmits an incident notification to a remote monitoring station. A camera associated with the device transmits images to the station, where an operator can view and assess the nature of the incident, communicate by voice and/or video with the occupant of the vehicle via a cellular telephone connection, and dispatch assistance. Assistance may include sending a replacement vehicle.

### FIELD OF THE INVENTION

The present invention relates to a system with an in-vehicle device for detecting vehicular incidents and related systems and methods of automatically detecting vehicular breakdowns and accidents, remotely assessing the incidents and dispatching appropriate assistance, including sending a replacement vehicle.

### BACKGROUND OF THE INVENTION

Motor vehicles can break down and become inoperable, potentially leaving a motorist stranded and in need of assistance and a replacement vehicle. Motor vehicles also become involved in collisions, which also leave a motorist in need of assistance, potentially emergency medical assistance. An injured motorist may be unable to call for help. Although systems exist which can automatically detect a collision, such as by detecting when an airbag has deployed and report the deployment to a monitor, they do not allow a remote monitor to assess the nature and severity of the incident. Although some systems permit a remote operator to attempt to contact the motorist by cellular telephone, an injured motorist may not even be able to respond by voice.

A need therefore exists for a system and method of automatically detecting a vehicle breakdown or collision, remotely assessing the nature and severity of the situation and dispatching the appropriate type of assistance. Depending on the nature and severity of the incident, the assistance may include sending a replacement vehicle and/or dispatching a mechanic, towing service or emergency response service to a motorist.

### BRIEF SUMMARY OF THE INVENTION

In accordance with one aspect of the present invention, a system is provided for monitoring a vehicle's status and detecting an incident such as a mechanical breakdown or collision. The system includes an in-vehicle electronic device configured to receive and monitor data from vehicle systems and a variety of sensors in the device or on the vehicle. Upon detection of an incident such as a system failure or collision, the device automatically transmits the telematics data to a remote monitoring station.

In one embodiment, the device may comprise a GPS device which automatically provides the vehicle's location.

In accordance with another aspect of the present invention, upon receiving a signal at a remote monitoring station indicating a vehicle incident, an operator activates a camera in the vehicle and remotely makes a visual assessment of the incident.

In accordance with another aspect of the present invention, after assessing the nature of the incident, the operator dispatches appropriate assistance, which may include sending a replacement vehicle.

### BRIEF DESCRIPTION OF THE DRAWINGS

FIG. 1 is a perspective view of a vehicle having an in-vehicle electronic device according to the invention disposed therein.

FIG. 2 is a perspective view of an in-vehicle electronic device according to the invention.

FIG. 3 is a perspective view of an alternate location of an in-vehicle camera in accordance with one embodiment of the invention.

FIG. 4 is a schematic representation of a system according to the invention.

### DETAILED DESCRIPTION OF THE INVENTION

With reference to the accompanying Figures, in accordance with the present invention, an in-vehicle electronic device, system and method for automatically detecting an incident such as a vehicle breakdown or collision, remotely assessing the nature and severity of the incident and dispatching the appropriate type of assistance are described in this section. The invention is particularly suitable for use in rental vehicles and leased fleet vehicles but may also be used with personal vehicles. The system and method of the invention are intended as a comprehensive solution to provide a customer with convenience, safety and peace of mind when operating a motor vehicle.

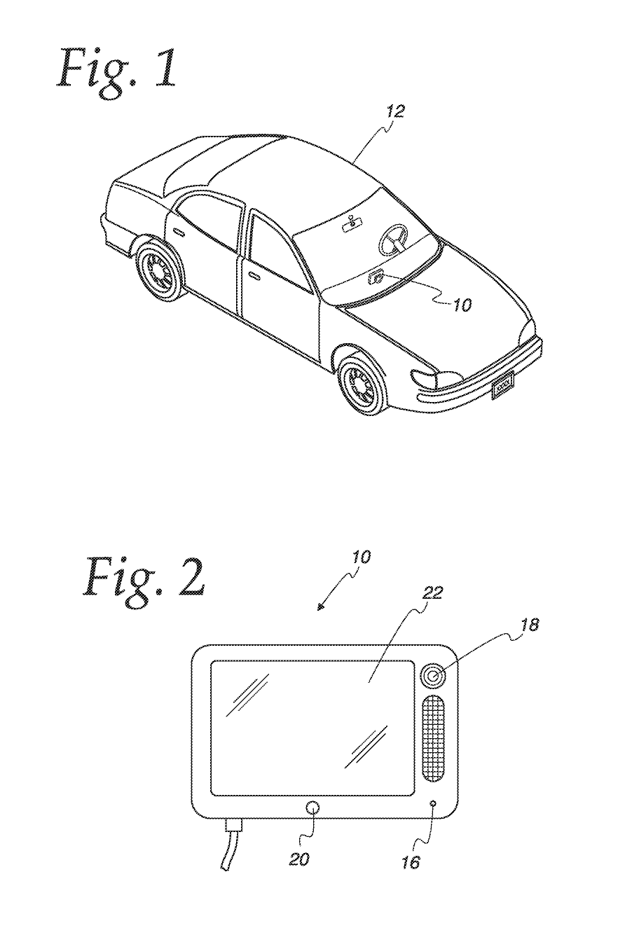

In particular, the system includes an in-car device 10 configured to be located in a vehicle 12, as illustrated in FIG. 1. In-car device 10 is configured to send and receive data to and from a remote server 14 operated by a vehicle monitoring service, with a human operator at customer service representative (CSR) terminal 24, as depicted schematically in FIG. 4.

Although depicted in FIGS. 1 and 2 as a single, separate unit mounted in the passenger compartment of vehicle 12, all or part of device 10 may be integrated into vehicle 12, and device 10, or some components thereof, may be located inside the cabin, engine compartment or trunk of vehicle 12. In-car device 10 may be any suitable device of a size and configuration to be conveniently located in vehicle 12, as long as the device includes a microprocessor, a memory, wireless communications connectivity, and GPS capability. GPS capability may be provided by a dedicated GPS device included in device 10, or by connecting or causing device 12 to communicate with an on-board OEM or consumer-installed GPS device located in vehicle 12. In-car device 10 is configured to operatively connect to vehicle 12 to receive data from vehicle 12, as discussed in more detail below

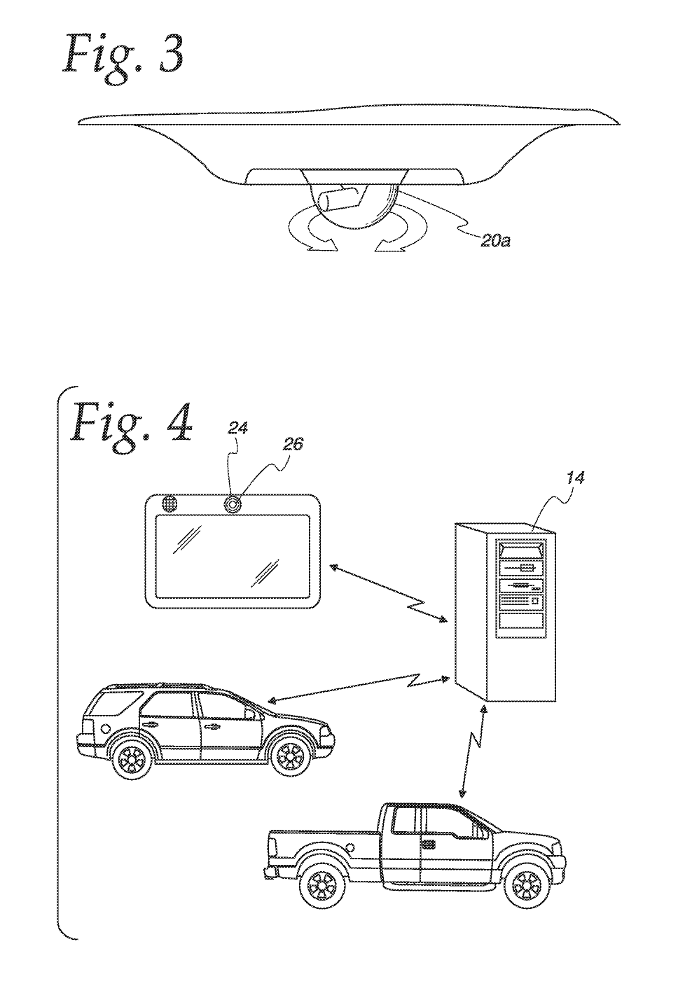

A microphone 16, speaker 18 and at least one camera 20 are included in or connected to device 10. One or more of these components may be physically integrated with device 10 or located remotely in the cabin, for example, in or on the dashboard, in the rear view mirror housing or in an overhead console. For example, camera 20a may be mounted in an overhead console as shown in FIG. 3. Microphone 16 and/or speaker 18 may be dedicated devices or may be integrated with the vehicle's audio and/or cell phone system.

Camera 20 or 20a is positioned so that its field of view includes at least the driver's seat area, and preferably the passenger seats as well. Camera 20 or 20a is preferably movable so that it can be panned, as indicated in FIG. 3, and may be equipped with a zoom lens. For privacy reasons, camera 20 and microphone 16 are preferably normally disabled, and are enabled only in the event of an incident as described below. Camera 20, 20a may be rotatable and suitably positioned, or alternately an additional camera (not shown) may be provided, to capture a forward field of view through the windshield of vehicle 12. The forward-facing camera may be located for example, on the forward-facing side of device 10, or in or on the dashboard, in the rear view mirror housing or in an overhead console of vehicle 12 as shown in FIG. 3. The forward-facing camera is preferably always active and enabled, and images or video provided by the camera are stored, in memory in in-car device 10 and/or at remote server 14. Preferably, the most recent thirty seconds or so of images or video are stored, which may be valuable in reviewing events leading up to a crash or other vehicle incident.

Optionally, device 10 may also include or be connected to a graphical user display 22, which may be a touch screen or other suitable display screen, and a user input device or mechanism, which may for example be touch screen 22, a keypad, or a touch pad separate from a display screen, or simple button to activate microphone 16. In-car device 10 may be fully customized device, built solely for purposes of the system of the invention, or may be integrated with other onboard systems. Alternatively, in-car device 10 may be a custom-programmed mobile personal electronic device such as a mobile telephone, PC, or tablet, for example, provided the device includes a camera. It should be understood that the in-car device is not limited to a device that is affixed permanently inside a vehicle, but also includes fully portable devices which may be used both within a vehicle and elsewhere. Such a device should, however, be securely mounted in a bracket (or by other removable attachment means) in the vehicle so that its camera can capture an image of the driver's seat. Where the portable device is a customer's personal electronic device such as a mobile smartphone, the device may be custom programmed by the user downloading a custom application (“app”) provided by a system operator, which may be, for example, a rental car service, leased fleet operator or independent system operator.

Device 10 is connected to a variety of sensors on the vehicle. Typically these sensors will be preinstalled on the vehicle as parts of OEM vehicle systems, but the system of the invention may include additional custom-installed sensors which are included in or connected to device 10. Device 10 receives data from the sensors concerning various states and conditions of vehicle 12, such as fuel level, oil pressure, coolant/antifreeze level, transmission or brake fluid level, tire pressure, engine temperature, battery charge level, etc. Device 10 is preferably also connected to the vehicle's on-board diagnostics system from which it receives vehicle maintenance codes indicating mechanical failures. Device 10 is also configured to receive a signal if one or more airbags are deployed, and alternately may be connected to receive signals from one or more collision sensors located on the bumpers or other parts of the vehicle. Other sensors may be added to detect conditions such as a vehicle rollover or unusually large amounts of pitch and/or yaw.

Preferably, device 10 is integrated with, or receives data from, the vehicle's onboard telematics systems. Vehicle telematics encompasses all types of automation in automobiles, such as an emergency warning system, GPS navigation, integrated hands-free cell phones, wireless safety communications and automatic driving assistance systems

In-car device 10 also provides a direct wireless data and voice communications link to the monitoring service. Upon detection of a vehicle incident, device 10 automatically transmits data via the link including an identification of vehicle 12 and the subscriber, the geographic location of vehicle 12 based on GPS data, and a signal indicating the nature of the incident, i.e., mechanical breakdown or collision. Transmitted data may also include data concerning the state of the various vehicle systems and sensors.

If in-vehicle device 10 detects that vehicle 12 has broken down and is inoperable, device 10 sends a signal to server 14 indicating the nature of the mechanical problem and the location of vehicle 12 as determined by GPS data. A customer service agent using terminal 24 connected to server 14 can initiate voice communication with the customer utilizing built-in or linked peripherals associated with device 10, and then dispatches a mechanic, towing service and/or a replacement vehicle to the customer's location.

If in-vehicle device 10 detects that vehicle 12 has been involved in a collision, device 10 sends an emergency signal to server 14 indicating that a collision has occurred and the location of vehicle 12 as determined by GPS data. The signal may also include any available data relating to the collision, such as whether any airbags have deployed and, if so, which ones. Software running on server 14 analyzes the data transmitted from device 10 to determine the nature of the incident and the vehicle's location, and displays this information on CRS terminal 24.

In response to the emergency signal, camera 20 in vehicle 12 is activated, preferably automatically but optionally manually by the system operator at CSR terminal 24, permitting the operator to remotely view the scene of the accident including the driver and any passengers. If the camera is so equipped, the operator may remotely pan it and/or operate the zoom lens to obtain a better view of the situation in the vehicle. If the camera(s) provides a view of the exterior of vehicle 12, the operator may also be able to visually assess the extent of damage to the vehicle. The operator using terminal 24 is also connected to vehicle 12 by cell phone and can communicate with the driver and/or passengers via microphone 16 and speaker 18 in vehicle 12. Based on the visual assessment and/or conversation with the driver and/or passengers, the operator then contacts the appropriate emergency responders (police, ambulance, towing service, et al.) to the vehicle's location. The operator also dispatches a replacement vehicle to the scene, or to another location as appropriate.

CSR terminal 24 preferably includes a camera 26 which captures an image of the customer service representative. The system permits not only live voice but also live video connectivity between the customer service representative and the occupants of vehicle 12. The customer service representative can thereby assure the vehicle occupants that assistance is on the way, update the vehicle occupants on the status and expected arrival time of assistance, and generally provide a level of comfort to the vehicle occupants until help arrives on the scene. The customer service representative can also visually and audibly monitor the situation in the vehicle and relay updates to emergency responders on a separate phone line or radio communications channel.

An individual customer may purchase a subscription for the service either as an option on a car rental contract or for a personal vehicle. If the subscription is purchased in connection with a rental, it runs for the term of the rental. Alternately, a customer may subscribe on a periodic (e.g., annual) basis to automatically have the service on all rentals from the rental agency during the subscription period, or the rental agency may offer the service as part of a premium or preferred customer package. Subscription information may be included in a customer profile so that the service is automatically included by default each time the customer reserves a rental vehicle. If a subscription is for a personal vehicle, it will run for a fixed period such as one year. A subscription for a personal vehicle may be limited to a certain number of replacement vehicles during the term (e.g., two per year) with additional replacement vehicles provided at an additional charge. A leased fleet manager may purchase subscriptions to cover all of the vehicles in its fleet on a periodic or other basis.

Subscriptions may be purchased in any suitable manner, such as by telephone when reserving a rental vehicle or at the rental desk or kiosk, but preferably a customer can also subscribe via a website using a computer, smart phone or other personal electronic device.

Upon receipt of an incident signal from a vehicle, software running on server 14 can automatically identify the vehicle and match it with a subscriber; and determine whether the vehicle is a rental vehicle or a private vehicle whose owner has subscribed to the service.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A system for detecting and assessing a vehicle incident, comprising:
an in-car device configured to be located in a vehicle and configured to receive data indicating the status of at least one of the vehicle's systems;
the in-car device comprising a GPS device;
a remote monitoring station in wireless data communication with the in-car device;
the in-car device being further configured to detect a vehicle incident based on the data and to transmit an incident notification to the remote monitoring station;
the notification including an identification of the type of incident based on the data and information provided by the GPS device identifying the location of the vehicle;
the in-car device further comprising a camera positioned to capture an image of at least a portion of the passenger compartment of the vehicle.

2. The system of claim 1, wherein the camera is capable of being remotely activated by an operator at the remote monitoring station.

3. The system of claim 2 wherein the camera is normally disabled until activated by the operator in response to an incident notification.

4. The system of claim 1 wherein the camera is rotatable to capture a forward field view through the windshield of the vehicle.

5. The system of claim 1, the in-car device further comprising a second camera positioned to capture a forward field view through the windshield of the vehicle.

6. The system of claim 1, the in-car device further comprising a microphone, a speaker and a two-way wireless audio transmitter/receiver for voice communication with the remote monitoring station.

7. The system of claim 1 wherein the device is connected to and receives input from at least one sensor on the vehicle for sensing a vehicle condition selected from a group consisting of a fuel level, an oil pressure, a battery charge level, a fluid level, an engine temperature, a brake wear condition, a tire pressure, an airbag deployment, a collision, a rollover or an excessive amount of pitch or yaw.

8. The system of claim 1 wherein the data comprises telematics data from the vehicle's onboard telematics systems selected from a group consisting of an emergency warning system, a GPS system, a navigation system, an automatic driving assistance system, an integrated hands-free cellular telephone and a wireless safety communications system.

9. The system of claim 1 wherein the notification includes an identification of the vehicle and a system subscriber.

10. A method for detecting and assessing a vehicle incident comprising;
providing an in-car device configured to be located in a vehicle and to receive and transmit data indicating the status of at least one of the vehicle's systems, the in-car device comprising a camera positioned to capture at least an image of at least a portion of the passenger compartment of the vehicle;
detecting a vehicle incident based on the data;
transmitting an incident notification from the in-car device to a remote monitoring station;
transmitting an image from the camera to the remote monitoring station; and
assessing, at the remote monitoring station, the incident based on the image.

11. The method of claim 10 further comprising controlling the camera from the remote monitoring station.

12. The method of claim 10 wherein the camera provides a forward-field view through the windshield of the vehicle, further comprising obtaining and storing a predetermined quantity of recent images from the camera.

13. The method of claim 10 further comprising the step of dispatching assistance to the vehicle based on the assessment.

14. The method of claim 13 wherein the assistance comprises sending a replacement vehicle.

15. The method of claim 10 wherein the device has wireless voice connectivity and further comprising the step of activating from the remote monitoring station a microphone and a speaker operatively connected to the device to permit voice communication between an operator at the remote monitoring station and an occupant of the vehicle.

16. The method of claim 15 wherein the device has wireless video connectivity and further comprising the step of enabling live video communication between the operator and an occupant of the vehicle.
